(19) United States
(12) Patent Application Publication
(10) Pub. No.: US 2014/0145525 A1
(43) Pub. Date: May 29, 2014

(54) REDUCED COGGING TORQUE PERMANENT MAGNET MACHINE

(71) Applicant: PRATT & WHITNEY CANADA CORP., Longueuil (CA)

(72) Inventor: Kevin Allan DOOLEY, Toronto (CA)

(73) Assignee: PRATT & WHITNEY CANADA CORP., Longueuil (CA)

(21) Appl. No.: 13/687,750

(22) Filed: Nov. 28, 2012

(51) Int. Cl. H02K 1/27

(52) U.S. Cl. CPC H02K 1/2706
USPC 310/51

(57) ABSTRACT

An electric machine is formed by a stator and a rotor that is free to rotate about an axis of rotation. The stator may have teeth projecting from a body portion and that define slots for housing electrical windings. The rotor may have a rotor core and a number of magnets supported on a peripheral face of the rotor in substantially contiguous arrangement and of alternating magnetization. The rotor magnets are shaped so that pairs of adjacent magnets oppose one another along magnetic boundary lines that are skewed relative to the slots formed in the body portion of the stator. For example, the shape of the rotor magnets may be arcuate trapezoidal or parallelogramatic. In this configuration, cogging torque experienced by the rotor during operation of the electric machine may be reduced.

### TECHNICAL FIELD

The disclosure relates generally to permanent magnet machines, and more particularly to magnet assemblies for permanent magnet machines.

### BACKGROUND

Brushless electric machines (including electronically-commutated and permanent-magnet motors and generators) have a wide variety of uses and/or applications, for example, including in electric starters, electrical transport drive motors, alternators, throttle controls, power steering, fuel pumps, heater and air conditioner blowers, and engine cooling fans, among other potential uses and/or applications.

In a typical brushless machine, a rotor is equipped with a number of permanent magnets, while the stator houses a number of electric windings that operate as controlled electromagnets. Brushless machines can operate in the same way as or similar to brushed machines, except that for example the mechanical switching function provided by the combination brush and commutator in a brushed machine can be replaced by electronic switching of the windings in a brushless machine. Accordingly, in a typical brushless motor, permanent magnets mounted to the rotor provide a static magnetic field relative to the rotor, and a rotating magnetic field is generated by commutating the stator windings with electronic switches. Field-Effect Transistors (FETs) and other types of solid state devices may be used for this purpose.

For sustained torque generation, a feedback sensor, such as a Hall effect sensor, can be installed on the stator or non-rotating structure to detect the angular position of the rotor in order to control timing of switches.

Relative to brushed machines, brushless machines have many potentially significant advantages, including high reliability and long life. For example, in a brushless motor, bearings are usually the only parts to exhibit wear over time. Brushless motors also often outperform brushed motors in applications where high speeds are required (e.g., above 12,000 RPM) because high speed operation of brushed motors tends to accelerate wearing of the mechanical brushes. At the same time, it is also often possible for brushless motors to achieve more precise and sophisticated motor control because of their electronic commutation.

Challenges sometimes associated with brushless machines include cogging torque, which may be characterized by a non-uniform torque developed on the rotor as a function of rotor position. Such torque can be caused by interaction of the rotor magnetization and angular variations in the magnetic permeance (or reluctance) between rotor and stator resulting from the geometry of the stator. Cogging torque may decrease operational efficiency of brushless motors, and can cause both torsional and radial vibration with attendant durability and noise problems.

### SUMMARY

In one aspect, the disclosure provides electric machines having at least one stator and at least one rotor accommodated by the stator in mutual alignment with, and rotatable about, an axis of rotation. In various embodiments, machines according to such aspect of the disclosure include one or more body portions and a plurality of teeth projecting from the body portion(s), the teeth being spaced apart angularly from one another around the axis of rotation and defining a corresponding plurality of slots in the body portion(s) set parallel to the axis of rotation that are adapted to receive one or more electrical windings. The at least one rotor may include a rotor core and a plurality of magnets supported on a peripheral face of the rotor core proximately opposed to the plurality of teeth of the stator across a gap, which may include an air gap. The plurality of magnets may be arranged such that the magnets are substantially contiguous with one another and of alternating magnetic orientation around the peripheral wall, and with each pair of adjacent magnets opposed to one another along a corresponding magnetic boundary line that is skewed in relation to each slot formed in the body portion(s) of the stator.

With such arrangements, cogging torque experienced during operation of an electric machine may be reduced.

In some embodiments, one or more of the plurality of slots may include a longitudinal slot opening oriented generally parallel to the axis of rotation.

In some embodiments, one or more corresponding magnetic boundary lines may be oriented non-parallel to the axis of rotation.

In some embodiments, the skew of one or more corresponding magnetic boundary lines has an angular component that equal to or greater than a corresponding arc length of each longitudinal slot opening.

In some embodiments, the skew of one or more corresponding magnetic boundary lines is approximately equal to the corresponding arc length between each longitudinal slot opening.

In some embodiments, one or more of the plurality of magnets has an arcuate trapezoidal shape defined by non-parallel sidewalls extending between angularly aligned top and bottom endwalls of different lengths.

In some embodiments, one or more of the plurality of magnets has an arcuate parallelogramatic shape defined by parallel sidewalls extending between angularly displaced top and bottom sidewalls of equal length.

In some embodiments, the plurality of teeth and the plurality of magnets may each be uniformly spaced around the axis of rotation.

In some embodiments, wherein the number of teeth in the plurality of teeth may be an integer multiple of the number of magnets in the plurality of magnets.

Further details of these and other aspects of the described embodiments will be apparent from the detailed description below.

### BRIEF DESCRIPTION OF THE DRAWINGS

Reference is now made to the accompanying drawings, in which:

FIG. 1 shows a radial cross-sectional view of a turbo-fan gas turbine engine;

FIG. 2A shows an exploded perspective view of a permanent magnet machine having an inner rotor configuration;

FIG. 2B shows an axial cross-sectional view of a permanent magnet machine having an inner rotor configuration;

FIG. 3A shows an exploded perspective view of a permanent magnet machine having an outer rotor configuration;

FIG. 3B shows an axial cross-sectional view of a permanent magnet machine having an outer rotor configuration;

FIG. 4A shows a perspective view of a rotor magnet configuration suitable for use in a permanent magnet machine;

FIG. 4B shows a side view of a rotor magnet configuration suitable for use in a permanent magnet machine;

FIG. 4C shows a top view of a rotor magnet configuration suitable for use in a permanent magnet machine;

FIG. 5 shows a flattened radial projection of a stator front face overlaid with rotor magnets of the configuration shown in FIGS. 4A-4C;

FIG. 6A shows a perspective view of another rotor magnet configuration suitable for use in a permanent magnet machine;

FIG. 6B shows a side view of another rotor magnet configuration suitable for use in a permanent magnet machine;

FIG. 6C shows a top view of another rotor magnet configuration suitable for use in a permanent magnet machine; and

FIG. 7 shows a flattened radial projection of a stator front face overlaid with rotor magnets of the configuration shown in FIGS. 6A-6C.

### DETAILED DESCRIPTION OF EMBODIMENTS

To provide a thorough understanding, various aspects and embodiments of machines according to the disclosure, including at least one preferred embodiment, are described with reference to the drawings.

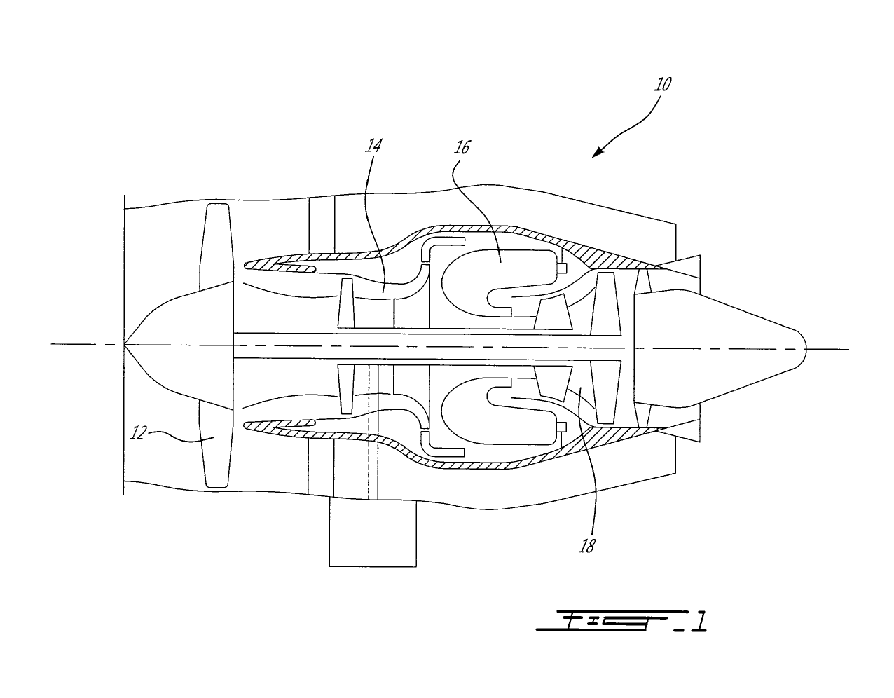

Reference is initially made to FIG. 1, which illustrates a gas turbine engine 10 of a type preferably provided for use in subsonic flight, generally comprising in serial flow communication a fan 12 through which ambient air is propelled, a multistage compressor 14 for pressurizing the air, a combustor 16 in which the compressed air is mixed with fuel and ignited for generating an annular stream of hot combustion gases, and a turbine section 18 for extracting energy from the combustion gases.

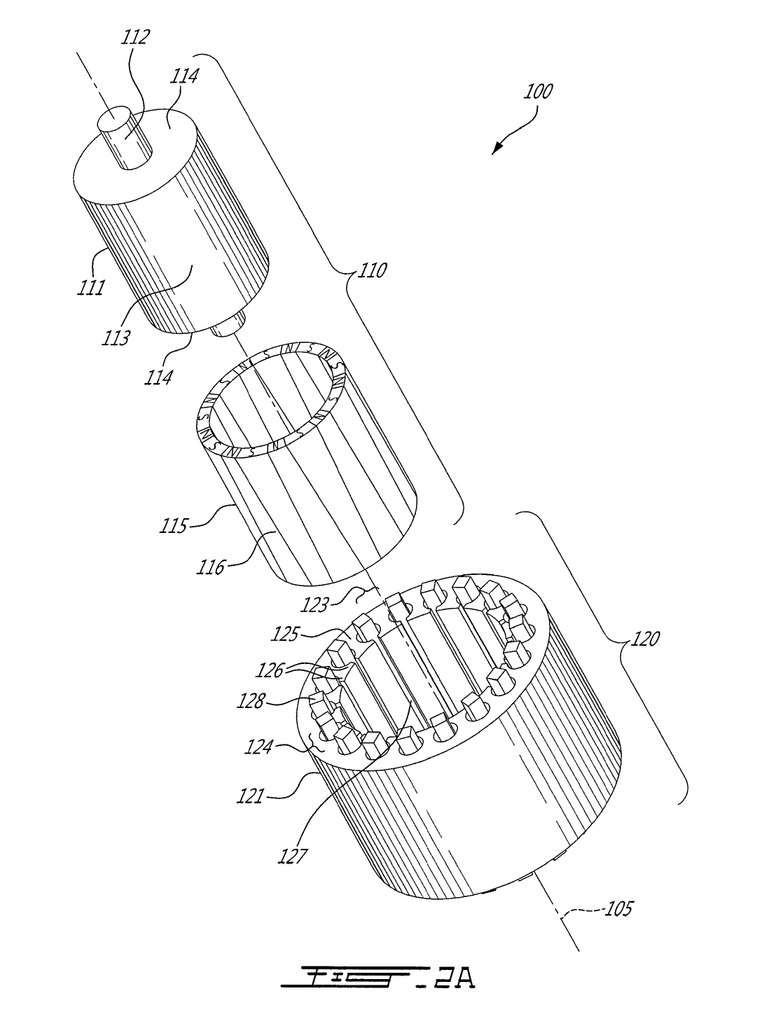

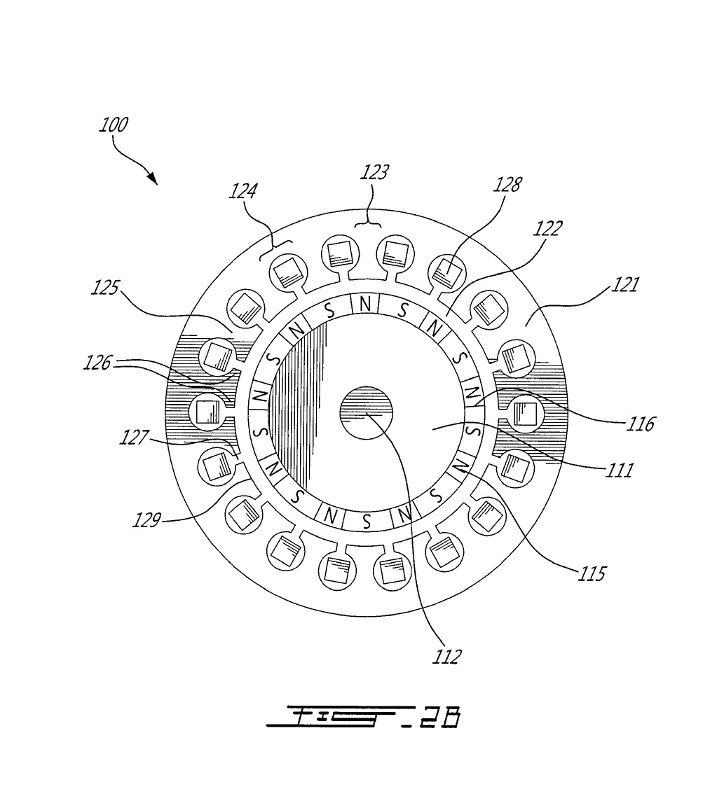

Referring now to FIGS. 2A and 2B, there is generally shown a permanent magnet (PM) machine 100 suitable for uses or applications such as a motor, generator, or motor-generator within a gas turbine engine 10 such as is illustrated in FIG. 1. However, PM machine 100 is not necessarily limited to use only in the gas turbine engine 10 and may be suitable for many other uses or applications, either with or without modification in the context of the present disclosure. The PM machine 100 is illustrated in both exploded perspective (FIG. 2A) and axial cross-sectional (FIG. 2B) views for convenience.

In the embodiment shown, PM machine 100 includes a rotor assembly 110 and a stator assembly 120 supported in mutual alignment for rotation about an axis of rotation 105. A stator assembly 120 may be fixedly secured or mounted within the PM machine 100, for example, on a frame, chassis or other suitable support member (not shown), while rotor assembly(ies) 110 may be supported by one or more bearings or other coupling members (not shown) so as to be rotatable, in relation to the stator assembly 120, and free to spin about the axis of rotation 105 during operation of the PM machine 100.

A rotor assembly 110 may include a rotor core 111, which may for example be supported on rotor shaft 112 and have a generally cylindrical body shape comprising an outer peripheral face 113 and opposing end walls 114. As shown in FIGS. 2A and 2B, opposing end walls 114 may be circular and give the rotor core 111 a generally circular cross-sectional profile. In other embodiments, rotor core 111 may instead have a polygonal cross-sectional profile, for example, a hexagon, octagon, or other shape. When used in the context of the rotor core 111, terms such as “cylindrical” or “cylindrical shape” may encompass any three-dimensional body having either a circular or polygonal cross-sectional profile.

In the embodiment shown, permanent magnets 115 are mounted on outer peripheral face 111 of rotor core 111, and affixed or otherwise permanently or removably attached thereto using any suitable mechanism. For example, permanent magnets 115 may be affixed to the outer peripheral face 113 using one or more retaining rings (not shown) or, additionally or alternatively, using any suitable bonding, laminate or adhesive layer(s), and/or mechanical fasteners such as rivets, bolts or composite material. Permanent magnets 115 may be arranged so as to form a contiguous or pseudo-contiguous ring around outer peripheral face 113, so that adjacent pairs of magnets 115 oppose one another at magnetic boundary lines 116 between pairs of magnets 115, either in abutment or separated by an air gap, depending on how tightly together the magnets 115 are packed.

Alternatively, depending on the selection of a suitable magnetic material, it may also be possible to provide a continuous layer of magnetic material, as opposed to a plurality of separate permanent magnets 115. Such continuous magnetic material may be magnetized in a way that substantially mimics or reproduces the magnetic field lines generated by permanent magnets 115. For example, a continuous magnetic material suitable for use in the described embodiments may be selectively magnetized in circumferential zones according to a desired magnetic pattern having skewed magnetic boundaries as are produced by the arrangement of permanent magnets 115 as described herein. Suitable magnetic materials for a continuous magnetic material may include alloys of neodymium, such as neodymium-iron-boron (NdFeB) alloys, or alternatively alloys of samarium-cobalt (SmCo), among others potentially. However, separately manufactured and bonded magnets such as permanent magnets 115 may in at least some cases provide a more cost effective implementation than a continuous magnetic layer.

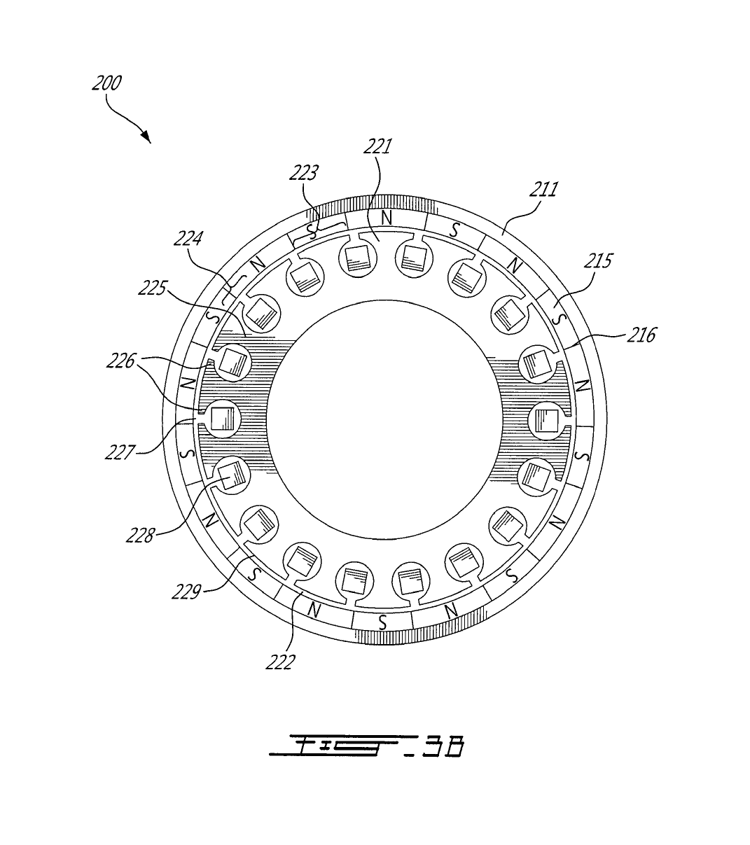

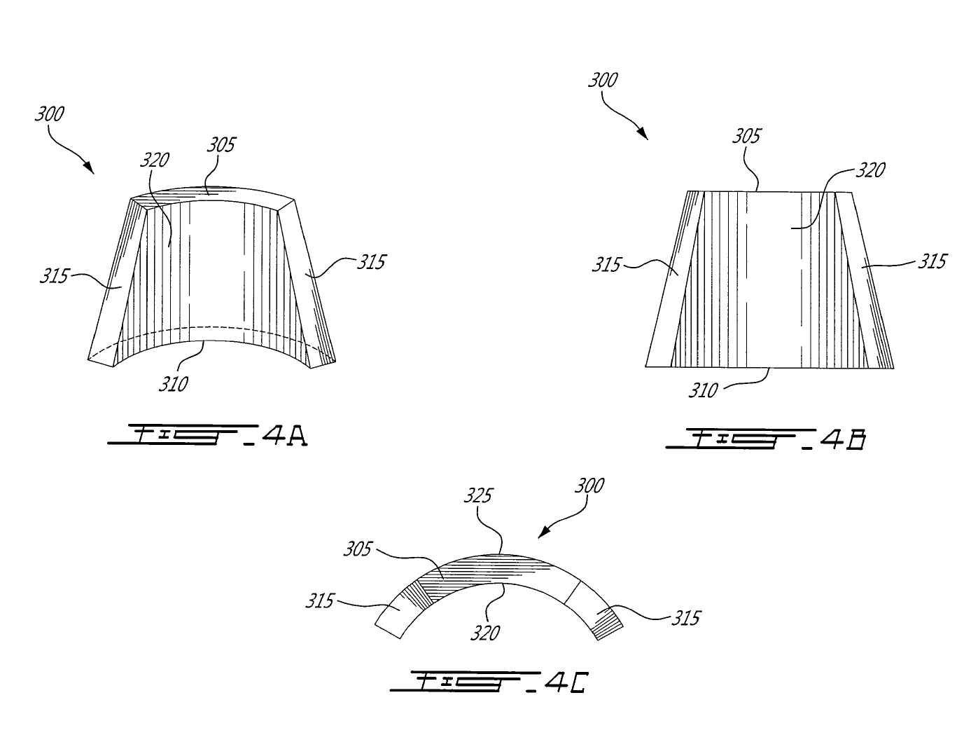

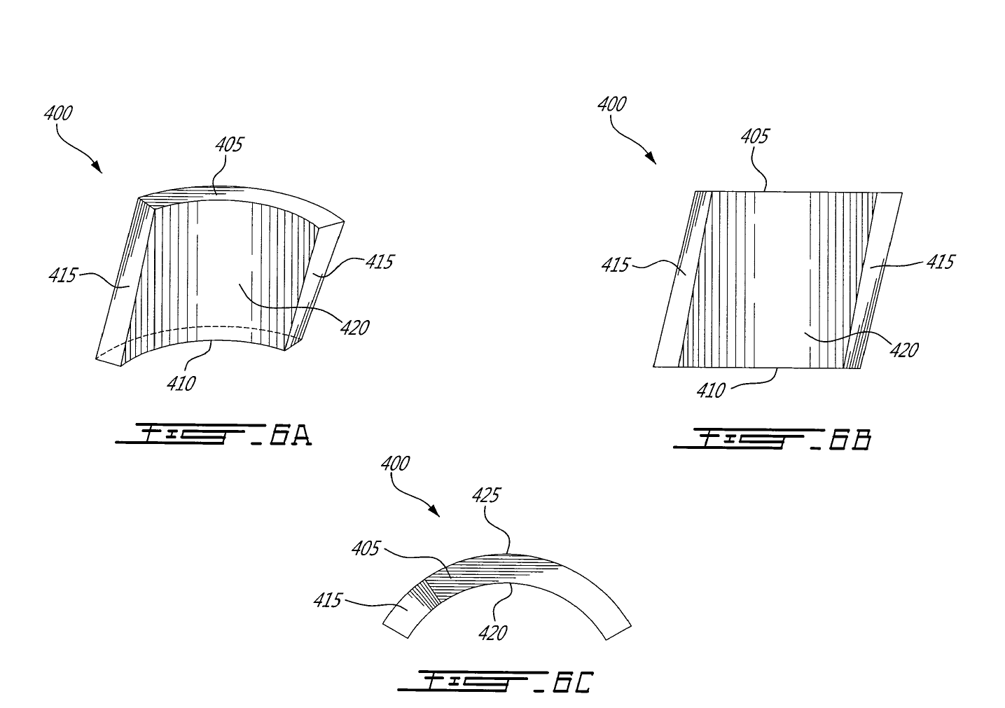

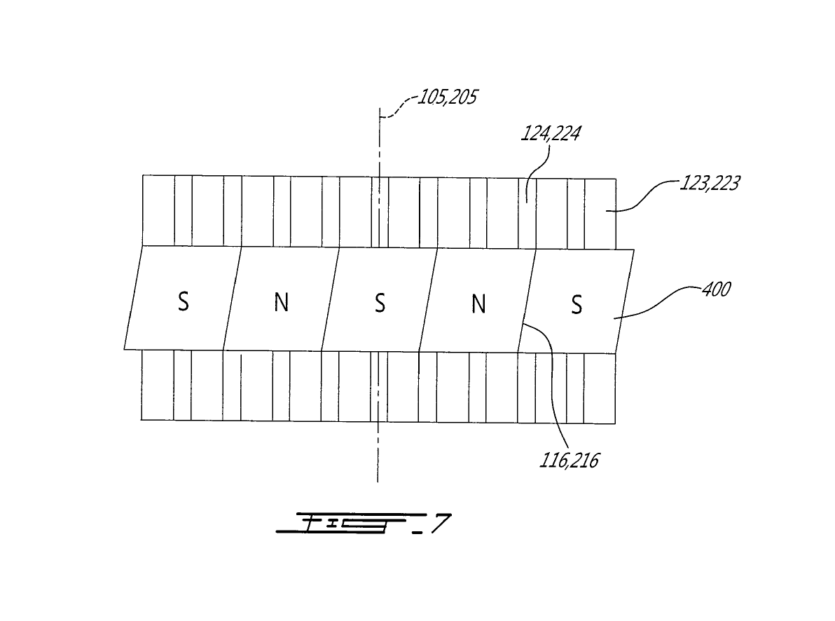

Permanent magnets 115 may be arranged to have alternating (North-South-North) magnetization in generally radial directions around outer peripheral face 113. With such arrangements, every second one of permanent magnets 115 may be aligned based on geometry and pointed in the same axial direction (e.g., with reference to the small end of the permanent magnets 115) and each having magnetizations characterized by “North” poles. Every other second one of permanent magnets 115 may thereby by aligned by geometry and pointed in the same but opposite axial direction (e.g., again with reference to the small end of the permanent magnets 115) and each having magnetizations characterized by “South” poles. In this arrangement, which is indicated in FIGS. 2A and 2B, half of permanent magnets 115 have a given magnetization which is opposite to the magnetization of another half of permanent magnets 115. Thus, magnetic flux may either emanate out of and lead into the outer peripheral face 113 in a generally radial direction, respectively, depending on the given magnetization of each permanent magnet 115. For convenience, such arrangement of permanent magnets 115 is referred to as having an “alternating magnetization”. Further description of permanent magnets 115 is provided below with particular reference to FIGS. 4A-4C and 6A-6C.

In the embodiment shown, stator assembly 120 includes a stator body portion 121 that defines an interior space shaped and sized to accommodate rotor assembly 110 within the interior space. (Such a configuration is commonly referred to as an “inner rotor” or “inside rotor” configuration to reflect the relative positioning of the rotor assembly 110 within the interior space). As shown in FIGS. 2A and 2B, stator body portion 121 may be annular or ring-shaped, for example, with the effect of conserving material, but in general may be any other three-dimensional body defining a suitably sized interior space for accommodating the rotor assembly 110 therewithin.

More particularly, an interior space compatible with the disclosure may have a cross-sectional profile matched to a uniform or varying cross-sectional profile of the rotor assembly 110 (including both the rotor core 111 and the magnets 115), but of a slightly larger size, so as to provide a small air gap 122 between the magnets 115 and the stator body portion 121. The air gap may have a generally constant radial width of a pre-determined value to improve the operation of the PM machine 100, as explained further below.

A number of teeth 123 may be formed or otherwise provided in the stator body portion 121 and which define a corresponding number of slots 124 interleaved between the teeth 123. Some or all of teeth 123 may have a stem portion 125 projecting from the stator body portion 121 in an inwardly radial direction, and which may flare into two tangential arm portions 126. Accordingly, each slot 124 may be formed to include a slot opening 127 between an opposing pair of tangential arm portions 126, one from each of a corresponding adjacent pair of the teeth 123. In various embodiments, slot opening(s) 127 may have longitudinal shape(s), profile(s), or trajectory(ies) oriented generally parallel to axis of rotation 105.

Further, some or all of slots 124 may gradually expand, in an outwardly radial direction, into relatively larger cavity portion(s) in which electrical windings 128 may be wound. For convenience, electrical windings 128 are depicted as disconnected circuit paths (e.g., wires), although electrical windings 128 may include any number of continuous paths. Electrical windings 128 be connected to an external drive circuit (not shown) that includes at least one electronic switch, such as a FET or other switchable semiconductor device that may provide electronic commutation of electrical windings 128 during operation of the PM machine 100.

Tangential arm portions 126 may be sized such that inner faces of teeth 123 form an inner peripheral face 129 of the stator body portion 121, which is continuous except where broken by slot openings 127. Inner peripheral face 129 may be proximately opposed to outer faces of magnets 115 across the air gap 122 to promote electromagnetic interaction between the static magnetic field generated by the magnets 115 and the rotating magnetic field generated by commutation of the electrical windings 128.

The size and shape of slot openings 127 may be a compromise between manufacturing cost and electromagnetic properties of PM machine 100. For example, slot openings 127 having a larger width may tend to reduce manufacturing cost by simplifying threading of the electrical windings 128 into the slots 124, whereas a smaller width for the slot openings 127 may tend to provided improved electromagnetic properties by reducing angular variations in the magnetic permeance of the air gap 122.

In some cases, the size of slot openings 127 may also be selected so as to effect control over a short circuit current generated within a permanent magnet machine. As the size of slot opening 127 may tend to affect the inductance of the electrical winding 128 housed therewithin, short circuit current flowing in the electrical winding 128 may be limited through control over inductance (which in turn may be related to the size of slot opening 127. Further description of the relationship(s) between slot openings 127, inductance of electrical windings 128, and short circuit current may be found in U.S. Pat. No. 7,119,467, filed Mar. 21, 2003, and entitled “CURRENT LIMITING MEANS FOR A GENERATOR”, the entirety of which is herein incorporated by reference.

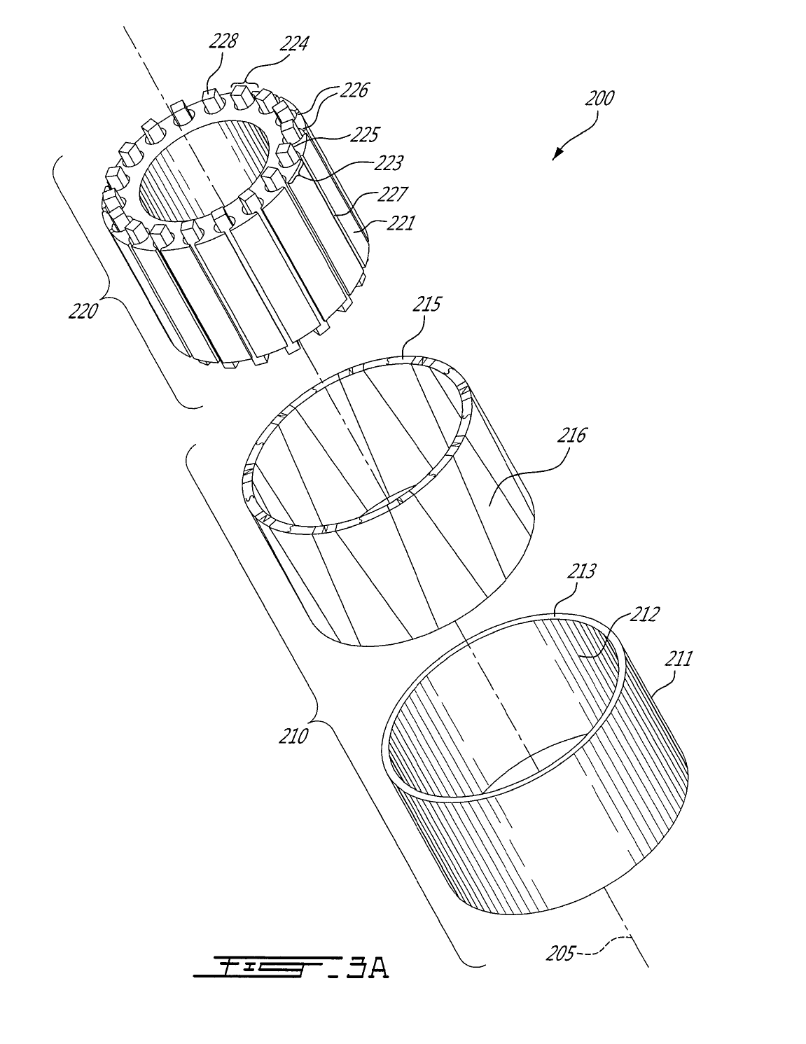

Referring now to FIGS. 3A and 3B, there is generally shown a permanent magnet (PM) machine 200 in both exploded perspective (FIG. 3A) and axial cross-sectional (FIG. 3B) views. In certain respects, the configuration and operation of PM machine 200 may be similar to PM machine 100 shown in FIGS. 2A and 2B, except that the PM machine 200 has an “outer rotor” or “outside rotor” configuration to reflect a different relative positioning of parts. For convenience, some description of the PM machine 200 that is common to the PM machine 100 may be omitted or abbreviated, while specific differences and/or dissimilarities may be emphasized or highlighted.

The PM machine 200 generally may include a rotor assembly 210 and a stator assembly 220, unlike the PM machine 100, now with the stator assembly 220 shaped and sized so as to be accommodated within an interior space defined by the rotor assembly 210. The rotor assembly 210 includes a rotor core 211 that may be a generally annular or shell-like body having an inner peripheral face 212 extending between opposing end walls 213. When used in the context of the rotor core 211, terms such as “annular” or “annular shape” may encompass any three-dimensional shell-like body having either a circular or polygonal cross-sectional profile. The rotor core 211 may be supported rotatably within the PM machine 200 on one or more bearings or other coupling members (not shown).

Permanent magnets 215 may be affixed or otherwise secured to inner peripheral face 212 of rotor core 211 (e.g., using a retaining ring, bonding or adhesive layer or other suitable mechanism). Similar to permanent magnets 115 (FIGS. 2A and 2B), permanent magnets 215 may be arranged around an inner peripheral face 212 with alternating magnetization (as indicated in FIGS. 3A and 3B), and forming a contiguous or pseudo-contiguous ring or shell of magnetized material. Adjacent pairs of magnets 215 may thereby again oppose one another at corresponding magnetic boundaries 216 between adjacent pairs of magnets 215, either in abutment or separated by a small air gap depending on how tightly together permanent magnets 215 are packed.

Stator assembly 220 may include a stator body portion 221 in which are formed a number of teeth 223 that define corresponding slots 224 in the stator body portion 221. Similar to teeth 123 (FIGS. 2A and 2B), teeth 223 may have a stem portion 225 that gradually flares into two tangential arm portions 226, with stem portion 225 projecting out of stator body portion 221 toward magnets 215 in an outwardly radial direction. Thus, each of slots 224 may be formed to include a slot opening 227 between an opposing pair of tangential arm portions 226, which may gradually expand in an inwardly radial direction into a relatively larger cavity portion in which electrical windings 228 are wound. Electrical windings 228 may lead to an external drive circuit and, for convenience, are again depicted as separate windings.

The size and shape of teeth 223 may again be such that an outer peripheral face 229 of the stator body portion 221, which is continuous except where broken by the slot openings 227, opposes magnets 215 across an air gap 222 of generally uniform radial thickness. Thus, an interior space defined by the rotor core 211 may have a cross-sectional profile matched to the cross-sectional profile of the stator assembly 220, but of a slightly larger radius. As used herein throughout in the context of either rotor core 111 and stator body 121 (FIGS. 2A and 2B) or rotor core 211 and stator body 212 (FIGS. 3A and 3B), the term “accommodated by” may encompass any shaping, sizing, spatial arrangement, disposition, and/or combination thereof, and/or any other configuration wherein one of rotor and stator may be housed, tightly or otherwise, within an interior space defined by the other of the rotor component so as to promote electromagnetic interaction of the static and rotating magnetic fields generated by these components.

In various embodiments, PM machines 100, 200 may operate in one or more different modes of operation, including at least a motor mode of operation and a generator mode of operation. During operation in a motor mode, drive voltage may be applied to electrical windings 128, 228 by, for example, an external voltage supply coupled to the electrical windings 128, 228. Thereafter, an electrical current flowing in the windings 128, 228 may induce a magnetic flux in the stator body portion 121, 221 having a rotating field configuration, which interacts with the static magnetic field generated by permanent magnets 115, 215. By commutating the externally applied drive voltage, a torque may be developed on the rotor core 111, 211 causing rotation thereof about the axis of rotation 105, 205.

Alternatively, when PM machines 100, 200 are operated in generator mode (sometimes also referred to as an “alternator mode”), an external torque may be exerted on the rotor core 111, 211 by, for example, a coupled load. As the rotor core 111, 211 rotates in response to the externally applied torque (or if already rotating in a counter direction, in resistance to the externally applied torque), a rotating magnetic field generated by the permanent magnets 115, 215 interacts with the structure of stator body portion 121, 221. This interaction produces a magnetic flux within stator body portion 121, 221 that loops windings 128, 228 and induces a terminal voltage across windings 128, 228. If windings 128, 228 are closed by an external circuit, the induced terminal voltage may be used to power one or more electrical loads driven by the external circuit, charge a storage device, or for any other suitable purpose.

In either mode of operation, practical and/or other non-ideal characteristics of PM machines 100, 200 may result in the creation of cogging torque during use. For example, owing to angular variation in the radial thickness of the stator body portion 121, 211, the magnetic permeance of the air gap 122, 222 may vary at different angular positions around the air gap 122, 222, depending on the presence or absence of magnetic material in the stator body portion 121, 211. In particular, the absence of magnetic material at various angular positions (i.e., at the locations of the slots 124, 224) can reduce the apparent magnetic permeance of the air gap 122, 222 relative to the permeance at other angular positions that coincide with the existence of magnetic material (i.e., at the locations of the stator teeth 123, 223). Simultaneously, a static magnetic field generated by the permanent magnets 115, 215 may exhibit radial variations due to leakage flux between pairs of adjacent, oppositely polarized magnets 115, 215 (i.e., of alternating magnetization. Such leakage flux can cause the magnetic field created in the vicinity of the magnetic boundaries 116, 226 to be generally weaker than the magnetic field existing near the center of the magnets 115, 225. A similar effect on the apparent permeance of the air gap 122, 222 can also in some cases result from magnetic saturation at one or more edges of stator teeth 123, 223. Thus, a contribution to cogging torque can be provided through either or both of these practical/non-ideal characteristics of a PM machine 100, 200.

As a rotor core 111, 121 spins about its axis of rotation 105, 205, at one or more discrete angular positions, one or more of magnetic boundaries 116, 216 between adjacent pairs of magnets 115, 215 may be directly opposed to one of slots 124, 224 rather than the front faces of the stator teeth 123, 223. When this occurs, a different magnetic field may be generated at magnetic boundaries 116, 216 and the relatively small apparent magnetic permeance of the air gap 122, 222 may interact to create an unbalance of tangential magnetic forces that alters the overall torque developed on the rotor core 111, 121. (At other angular positions, where no or less unbalance of tangential magnetic forces exists, the rotor core 111, 121 experiences a relatively uniform positive and negative torque, resulting in a net zero torque developed between the stator and rotor).

In brushless motors, such as PM machines 100, 200, cogging torque may serve as a significant, and even primary, source of vibrations, noise and torque fluctuations. As such, cogging torque may pose a significant design constraint in brushless motors. For example, vibrations and noise may affect performance and increase equipment wear, while torque fluctuations may become a particularly significant factor in high-performance, control applications, and in smooth starting/stopping of rotor rotation. Embodiments according to the disclosure may be suitable to eliminate, or at least to reduce the effects of, the cogging torque experienced by the rotor core 111, 211 during use and, thereby, to achieve improved starting/stopping, as well as more efficient and/or less destructive operation of PM machines 100, 200.

When a PM machine 100, 200 is operated in a generating mode, and cogging torque is reduced, at least in part, by utilizing configurations of magnets 115, 215, as described herein, improvement in the characteristics of an induced terminal voltage waveform may in some cases also be achieved. For example, by reducing cogging torque, harmonic distortion in an induced terminal voltage on electrical windings 128, 228 of a PM machine 100, 200 may also be reduced, which can advantageously lead to a more sinusoidal voltage waveform being developed. As output power in PM machine 100, 200 may generally correspond to input power (notwithstanding losses due to practical or non-ideal components), given a relatively constant speed, a non-steady state input power (such as might be expected if significant cogging torque or other torsional disturbance is developed) may be expected to translate into harmonic distortion in the output power characteristic. Conversely, to achieve an ideal or near ideal 3-phase sine function in output power might imply no or very little cogging torque and/or torsional disturbance being present.

Referring now to FIGS. 4A-4C, there is shown a configuration of a rotor magnet 300, which may be suitable for use in either a PM machine 100 (FIGS. 2A-2B) or a PM machine 200 (FIGS. 3A-3B). In the embodiment shown, rotor magnet 300 has an arcuate trapezoidal (sometimes referred to as a “keystone”) shape defined by a top end wall 305, a bottom end wall 310, side walls 315, an inner face 320, and an outer face 325 generally opposing the curved inner face 420.

Top end wall 305 may be angularly aligned with and generally parallel to, but of a different length than, the bottom end wall 310. In some embodiments, top end wall 305 may be shorter than bottom end wall 310 to provide the rotor magnet 300 with such generally trapezoidal or keystone configuration. As used herein throughout in the context of the rotor magnet 300, the terms “top end wall” and “bottom end wall” do not necessarily indicate or relate direction, orientation or alignment in an absolute sense. Rather these terms are used for convenience to reference different aspects or features of the rotor magnet 300. For example, “top end wall” and “bottom end wall” may refer merely to the shorter and the longer of these two end walls, respectively.

Inner face 320 and outer face 325 of magnet 300 are generally parallel to one another and each have a curved or arcuate surface contour defined by a corresponding radius of curvature. As explained further below, the radius of curvature of inner face 320 may be approximately equal to the radius of curvature of the outer peripheral face 113 of the rotor core 111 to allow for a tight fit between rotor magnet 300 and a rotor core 111. Alternatively, in the case of the PM machine 200, the radius of curvature of outer face 325 may be approximately equal to the radius of curvature of the inner peripheral face 212 of the rotor core 211 to provide tight fit.

Sidewalls 315 extend between top and bottom end walls 305 and 310 are generally non-parallel to one another on account of the different lengths of the top and bottom end walls 305 and 310. In some embodiments, the sidewalls 315 are approximately of equal length to provide the rotor magnet 300 with an “isosceles” trapezoidal shape, whereby the angle subtended between each of the sidewalls 315 with the top end wall 305 (or bottom end wall 310) are equal or nearly equal. The sidewalls 315 may also be tapered, sloped or otherwise angled inwardly so that, when installed on the rotor core 111 (or the rotor core 211), the sidewalls 315 are oriented essentially orthogonal to the outer peripheral face 113 (or inner peripheral face 213). Thus, when a number of rotor magnets 300 are installed on either a rotor core 121 or 221, opposing sidewalls 315 from adjacent magnets may be brought into abutment or near abutment.

Referring back to FIGS. 2A-2B, each of a plurality of magnets 115 may have the configuration of the rotor magnet 300 shown in FIGS. 4A-4C. With such configuration, the plurality of magnets 115 may be affixed to the outer peripheral wall 113 in alternating relative orientation and magnetization to create a continuous or pseudo-continuous surface layer of magnetic material. Within the present disclosure, the term “alternating relative orientation” may used in reference to the geometric or spatial (as opposed to magnetic) configurations of rotor magnets 300, e.g., to reflect that adjacent rotor magnets 300 may point in opposite axial directions. However, relative orientation may also be related to magnetization in some cases. For example, each rotor magnet 300 may be magnetized so that the top end wall 305 is designated as “North” and the bottom end wall 310 is correspondingly designated as “South”. Alternating relative orientation thereby also alternates the relative magnetizations of the plurality of magnets 115, 215.

So that a plurality of magnets 115, in the case of a PM machine 100, is shaped into a generally cylindrical surface layer that fits tightly to and substantially circumscribes the outer peripheral wall 113 of the rotor core 111, not just radius of curvature, but also the number and size of the plurality of magnets 115 may be selected appropriately. In some embodiments, each rotor magnet 300 may have approximately the same arc length, optionally, selected as an integer fraction of the circumference of the peripheral face 113. Where each rotor magnet 300 is equally sized, when installed on the rotor core 111, the plurality of magnets 115 will also be uniformly spaced around the peripheral face 113. However, it may also be possible in some cases to use rotor magnets 300 of generally different sizes and still achieve tight fit and circumscription of the outer peripheral wall 113.

The number of the plurality of magnets 115 is variable and, optionally, may be related to the number of the teeth 123 formed in the stator body portion 121. In some cases, for example, such relationship may be as an integral fraction of the number of number of teeth 123. Thus, the number of the plurality of magnets 115 may equal the number of the teeth 123 or, alternatively, may be equal to one half, one third, one quarter, or any other integral fraction, of the number of the teeth 123. If related to the number of teeth 123 formed in the stator body portion 121, the number of the plurality of magnets 115 will in general be an even number (because the number of magnets 115 may be an even number of North and South polarized magnets). Generally, the number of teeth 123 and the number of magnets 115 may be related by the number of electrical phases to be generated in the PM machine, but could potentially may be related by some other requirement in alternative embodiments. In some embodiments, the plurality of teeth 123 may also be uniformly spaced around the inner peripheral face 129.

A trapezoidal or keystone shape of the rotor magnet 300 may also in some cases facilitate tight fitting on the rotor core 111. Due to machining tolerances and other practical limitations, it is not always possible or cost effective to manufacture rotor magnets 300 with precise and consistent dimensionality. With other configurations of rotor magnets, this machine tolerance would sometimes result in the formation of small air gaps between adjacent magnets when installed on the rotor face, which tend to adversely affect rotor balance.

However, with a trapezoidal configuration of rotor magnets 300, the presence of air gaps may be significantly reduced or eliminated altogether by allowing for slight axial displacement of one or more of the magnets 115. Even accounting for machining tolerances, by axial displacement of any or all of magnets 115 along the rotor core 111, opposing sidewalls 315 from adjacent pairs of the magnets 115 may be brought into near or substantial abutment with (in general “opposed to”) one another at corresponding magnetic boundaries 116. Resulting axial displacement of the magnets 115 tends to have only a relatively minor impact, if any, on the magnetic properties or performance of the PM machine 100. Accordingly, less accurate machining of the rotor magnet 300 may be possible without adversely affecting fit or rotor balance.

While the above description makes explicit reference to features and aspects of the PM machine 100 to explain various advantages of the rotor magnet 300, such description may apply equally to the PM machine 200 shown in FIGS. 3A-3B with appropriate modification or variation to reflect the “outside rotor” configuration of the PM machine 200. For example, similar to the PM machine 100, each of a plurality of magnets 215 in the PM machine 200 may also be realized using the rotor magnet 300 shown in FIGS. 4A-4C, except that the rotor magnets 300 may be affixed or otherwise secured to the inner peripheral face 212 of the rotor core 211. Otherwise, additional description of the plurality of magnets 215 may be found above in respect of the plurality of magnets 115 and, for convenience, will not be repeated here.

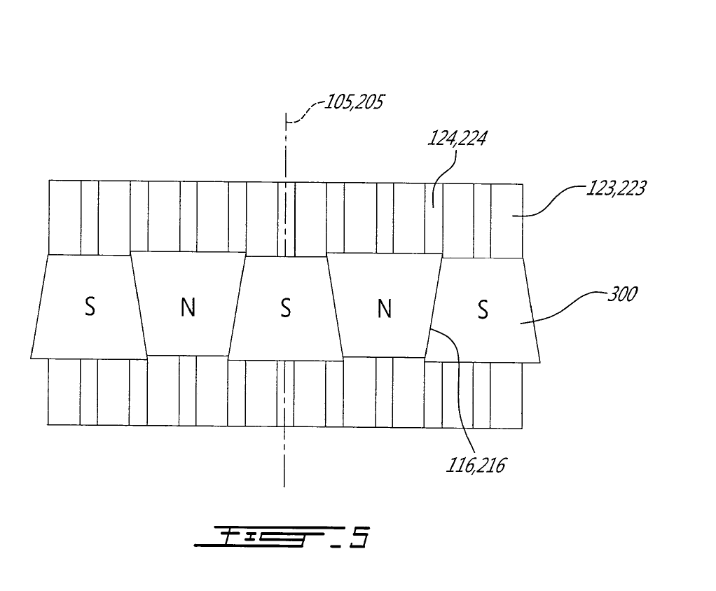

Referring now to FIG. 5, relative spatial relationships of rotor magnets 300 and stator slots is explained in further detail. For convenience, FIG. 5 shows a partial flattened, side projection of a stator body 121 (FIGS. 2A-2B) overlaid with a number of the rotor magnets 300. (Slight axial displacement of the rotor magnets 300 may be exaggerated in FIG. 5 to illustrate how tight packing of adjacent magnets may be achieved).

As described above, rotor magnets 300 are arranged in alternating magnetization and axial orientation and so that adjacent, oppositely magnetized pairs are generally opposed to one another at corresponding magnetic boundaries 116, 216. The number of the rotor magnets 300 shown in FIG. 5 is equal to half the number of stator teeth 123, so that the number of magnetic boundaries 116, 216 between opposing magnets 300 is also equal to half the number of stator slots 124, 224 formed between adjacent pairs of the teeth 123. In some embodiments, the number of teeth 123 may be equal to 12, 18, or some other multiple, such as an even multiple of three, as the case may be, depending on a number of poles formed in a PM machine 100, 200.

While FIG. 5 depicts a configuration of rotor magnets 300 that number half a corresponding number of stator teeth 123, as noted, other relative numberings are possible. Also, as described further below, the degree of cogging torque reduction will in general depend on the relative numbering of rotor magnets 300 to stator teeth 123. Arrangements such as FIG. 5 illustrates, in which the number of stator teeth 123 are an integer multiple of the number of magnets 300, may provide optimized (or at least pseudo-optimized) cogging torque reduction. The particular arrangement shown in FIG. 5 is for convenience of illustration only.

Each of the magnets 300 may also have substantially the same dimensions so that the angular spacing of the magnets 300 around the axis of rotation 105, 205 is uniform (equal to 2π/Nₘ, where Nₘ is the number of the rotor magnets 300). The stator teeth 123 may also have uniform angular spacing around the axis of rotation 105, 205 (given by 2π/P, where P=Nₚ×M and is equal to the product of the number Nₚ of poles and the number M of electrical phase windings). With these numbers and respective angular spacings of rotor magnets 300 and stator teeth 123, at certain angular positions of the rotor 111, 211, each of the magnetic boundaries 116, 216 is generally opposed to a corresponding one the stator slots 124, 224 across the air gap 122, 222 (FIGS. 2B and 3B).

Due to the trapezoidal shape and alternating configuration of the rotor magnets 300, magnetic boundary lines 116, 216 are skewed in relation to the orientation of slots 124. For example, slots 124 are oriented in a generally axial direction as defined by axis of rotation 105, 205, while the magnetic boundary lines have a non-zero angular component. Consequently, the projection of the magnetic boundary lines 116, 216 onto the flattened surface of the stator body intersects, and is not parallel, with the general trajectory of the slots 124. (Because the slots 124 have some finite width, the “general trajectory” of the slots is approximated by the magnetic boundary line running midway between adjacent pairs of teeth 123, 223.)

Skewing magnetic boundaries 116, 216 in relation to stator slots 124 tends to reduce the development of cogging torque during operation of the PM machine 100. As the rotor 111 spins, angling of magnetic boundary lines 116, 116 relative to the general trajectory of the slots 124 tends to reduce the imbalance of tangential magnetic forces that contribute to the cogging torque. Without skewing of magnetic boundary lines 116, the coincidence of the weakened magnetic field associated with the magnetic boundary lines 116 with areas of relatively low magnetic permeance is localized to a very narrow range of angular positions in which the magnetic boundary lines 116 project onto the stator slots 124. However, when magnetic boundary lines 116 are skewed in relation to the stator slots, the coincidence is spread out onto a larger range of angular positions to thereby provide more evenly balanced magnetic forces throughout each rotational cycle of the PM machine 100.

As shown in FIG. 5, the skew of the magnetic boundary lines 116 (measured in terms of angular component) is approximately equal to the arc length of the slot opening 124. However, the amount of skew provided may be varied in different embodiments and may generally be greater than or equal to the arc length of the slot opening 124. For example, increasing the amount of skew provided may tend to reduce or ameliorate adverse effects associated with cogging torque, but in general will also result in less torque generation overall. Conversely, less skew will in general increase overall torque generation, but may also tend to result in greater exhibition of cogging torque. Accordingly, the amount of skew may be varied to meet one or more different, and in some cases competing, design constraints and/or specifications.

In some embodiments, the angular component of the skew may depend on the radial width of the air gap to achieve a design-optimized reduction of cogging torque. Alternatively, or additionally, the angular component of the skew may depend on the distance between centers of teeth 123, 223 or between slot openings 124, 224, for example, as determined by the angle between each of the teeth 123, 223 or the angular width of opposing tangential arm portions 126 in stem portion 125. The angular component of the skew may further depend on the axial length or height of the stator body portion 121, 221.

An optimal (or pseudo-optimal) reduction of cogging torque may in some cases be achieved when magnets 300 are arranged relative to stator teeth 123, 223 such that one end of a given magnet 300 will be at a given position relative to a tooth 123, 223, and the opposite end of that magnet 300 will be at the same relative position on an adjacent tooth 123, 223. In some cases, a trapezoidal shaped magnet 300 may be half a tooth wider at one end and half a tooth narrower at the opposite end of magnet 300, thereby providing for a total difference of one tooth width taken from one end of magnet 300 to the opposite end.

The relationship designed to provide optimal (or pseudo-optimal) reduction of cogging torque may be expressed mathematically as follows:

$${φ}_{m} = {tan}^{- 1} ( \frac{2 π}{N} \frac{{R}_{s}}{{L}_{s}} ) , \qquad ( 1 )$$

where φₘ may represent a magnetic boundary edge angle relative to a tooth mean centre line for minimum cogging torque. For trapezoidal (keystone) shaped magnets 300, φₘ may be the angle of one side edge of magnet 300 relative to the opposite side edge (see FIGS. 4A-4C).

In equation (1) above, Rₛ represents a radius of stator body portion 121, 221 (or tooth surface), N represents a number of slots 124, 224 defined in stator body portion 121, 221, and Lₛ represents the axial length of a tooth 123, 223 swept by the magnet (included or common surface between magnet and tooth). Based on these defined parameters, magnet edge angle relative to the axis of tooth mean centerline is computed as the inverse tangent defined by equation (1), i.e., of the quotient of 2π multiplied by tooth surface radial position (stack diameter divided by two) and divided by the product of magnet included stack length and the number of slots 124, 224. As used herein, the term “magnet included stack length” may denote either the hypothetical axial length of the magnet if the stack was longer than the magnet or, alternatively, the hypothetical axial length of the stack if the magnet was axially longer than the stack.

The corresponding reduction in output torque when a PM machine is operating in motor mode from skewing of magnets as described herein may be given as follows:

$${T}_{c} = {T}_{n} \cdot cos ( \frac{π}{2} \frac{{N}_{m}}{N} ) , \qquad ( 2 )$$

where T_{c} represented corrected torque, Tₙ represents nominal torque, Nₘ represents a number of magnets (or poles), and N represents a number of slots (or teeth). Similarly, where a PM machine is being operated in a mode generator, the corresponding reduction in output voltage due to skewing of magnets may be given as follows:

$${V}_{c} = {V}_{n} \cdot cos ( \frac{π}{2} \frac{{N}_{m}}{N} ) , \qquad ( 3 )$$

where V_{c} represents corrected Voltage, Vₙ represents nominal Voltage, and Nₘ and N are defined as above for equation (2).

Based on the above equation, it is also possible to configure magnets 300 to provide a reduction in cogging torque ranging any amount generally from zero (no reduction) to the optimal (or pseudo-optimal) reduction indicated above. At maximum reduction in cogging torque, there may be experienced a reduction in available torque and voltage generation by about 15% from optimum settings. Accordingly, in some embodiments, there may exist a trade off between reduced cogging torque, output waveform distortion, and output power at a given size and speed of a machine.

Referring now to FIGS. 6A-6C, there is shown a configuration of a rotor magnet 400, which may be suitable for use in either PM machine 100 (FIGS. 2A-2B) or PM machine 200 (FIGS. 3A-3B). Rotor magnet 400 is shaped into an arcuate parallelogram defined by opposing end walls 405 and 410, opposing sidewalls 415, inner face 420, and an outer face 425 generally opposing the curved inner face 420. In some embodiments, rotor magnet 400 may be used as alternative to, or simultaneously with, the rotor magnet 300 (FIGS. 4A-4C).

End walls 405 and 410 may be generally parallel to one another and of the same length, but angularly displaced relative to a central axis (not shown) of the rotor magnet (400). Sidewalls 415 extend between the end walls 405 and 410 are also generally parallel to one another on account of the equal lengths of the end walls 405 and 410. Sidewalls 415 may also be tapered, sloped or otherwise angled inwardly so that, when installed on the rotor core 111 (or the rotor core 211), sidewalls 415 are oriented essentially orthogonal to the outer peripheral face 113 (or inner peripheral face 213). Similar to the above description, such angling of sidewalls 415 may facilitate arrangement of a number of the rotor magnets 400 with near or substantial abutment. For this purpose, the shape of the magnet 400 may also allow for slight axial displacement to ensure tight fit.

Similar to inner face 320 and outer face 325, inner face 420 and outer face 425 are generally parallel and each have a curved or arcuate surface contour defined by a corresponding radius of curvature that is approximately equal to the radius of curvature of the outer peripheral face 113 or the inner peripheral face 213, respectively. Again, this shaping of the rotor magnet 400 may facilitate fitting of a number of the magnets 400 tightly to the rotor core 111 or 121.

Referring now to FIG. 7, exemplary relative spatial relationships of rotor magnets 400 and stator slots are explained in further detail. Again, for convenience, FIG. 7 shows a partial flattened, side projection of the stator body 121 shown in FIGS. 2A and 2B overlaid with a number of the rotor magnets 400.

In the embodiment shown in FIG. 7, rotor magnets 400 are arranged in alternating orientation and magnetization around axis of rotation 105, 205 so that adjacent pairs are generally opposed to one another at corresponding magnetic boundaries 116, 216. Similar to the arrangement of FIG. 5, the number of the rotor magnets 400 shown in FIG. 7 is equal to half (although it need not be) the number of stator teeth 123, 223, so that the number of magnetic boundaries 116, 216 between opposing magnets 400 is also equal to half the number of stator slots 124, 224 formed between adjacent pairs of the teeth 123, 223. However, in alternative embodiments, the number of teeth 123, 223 may be other integer multiples of the number of magnets 400.

Due to the slanted rectangular shape and alternating configuration of the rotor magnets 400, the magnetic boundary lines 116, 216 are also skewed in relation to the orientation of the slots 124, 224. Consequently, the projection of the magnetic boundary lines 116, 216 onto the flattened surface of the stator body again intersects, and is not parallel, with the general trajectory of the slots 124, 224, which, like the skewing achieved by the rotor magnet 300, tends to reduce the development of cogging torque during operation of a PM machine 100, 200.

Similar to trapezoidal magnets 300 (FIGS. 4A-4C), different spatial relationships of parallogrammatic rotor magnets 400 and stator slots as shown in FIG. 7 may realize different relative reductions of cogging torque. In some embodiments, the relationship expressed in equation (1) above may again yield optimal (or pseudo-optimal) cogging torque reduction, where φₘ for parallelogram shaped magnets 400 may be the angle of each parallel side edge of magnet 400 relative to the slot edge (see FIGS. 6A-6C). In such cases, the expressions defined in equations (2) and (3) for corresponding reduction in output torque or voltage resulting from skewing of magnets as described herein may again hold true.

The above description is meant to be exemplary only, and one skilled in the art will recognize that changes may be made to the embodiments described without departing from the scope of the invention disclosed. For example, the relative number and sizing of rotor magnets may be varied in relation to the number of slots defined in the stator. Additionally, the rotor magnets need not all have the same shape or configuration and at least some of the rotor magnets may have a different configuration. In some cases, each magnetic boundary between adjacent rotor magnets may be skewed in relation to the stator slots, although in other cases, one or more of the magnetic boundaries may not be. Still other modifications which fall within the scope of the present invention will be apparent to those skilled in the art, in light of a review of this disclosure, and such modifications are intended to fall within the appended claims.

What is claimed is:

1. An electric machine comprising:
a stator comprising a body portion and a plurality of teeth projecting out of the body portion, the plurality of teeth being spaced apart angularly from one another around an axis of rotation and defining a corresponding plurality of slots in the body portion that are adapted to receive one or more electrical windings; and
a rotor accommodated by the stator in mutual alignment with and rotatable about the axis of rotation, the rotor comprising a rotor core and a plurality of magnets supported on a peripheral face of the rotor core proximately opposed to the plurality of teeth of the stator across an air gap, the plurality of magnets arranged to be substantially contiguous with one another and of alternating magnetization around the peripheral wall, and each pair of adjacent magnets opposed to one another along a corresponding magnetic boundary line that is skewed in relation to each slot formed in the body portion of the stator.

2. The electric machine of claim 1, wherein each of the plurality of slots comprises a longitudinal slot opening oriented generally parallel to the axis of rotation.

3. The electric machine of claim 2, wherein each corresponding magnetic boundary line is oriented non-parallel to the axis of rotation.

4. The electric machine of claim 2, wherein the skew of each corresponding magnetic boundary line has an angular component that equal to or greater than a corresponding arc length of each longitudinal slot opening.

5. The electric machine of claim 4, wherein the skew of each corresponding magnetic boundary line is approximately equal to the corresponding arc length between each longitudinal slot opening.

6. The electric machine of claim 1, wherein at least one of the plurality of magnets has an arcuate trapezoidal shape defined by non-parallel sidewalls extending between angularly aligned top and bottom endwalls of different lengths.

7. The electric machine of claim 1, wherein at least one of the plurality of magnets has an arcuate parallelogramatic shape defined by parallel sidewalls extending between angularly displaced top and bottom sidewalls of equal length.

8. The electric machine of claim 1, wherein the plurality of teeth and the plurality of magnets are each uniformly spaced around the axis of rotation.

9. The electric machine of claim 8, wherein the number of teeth in the plurality of teeth is an integer multiple of the number of magnets in the plurality of magnets.
